(19) United States
(12) Patent Application Publication
(10) Pub. No.: US 2006/0041404 A1
(43) Pub. Date: Feb. 23, 2006

(54) Apparatus, method, and computer product for generating model for numerical analysis

(75) Inventor: Akira Ueda, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 11/005,074

(22) Filed: Dec. 7, 2004

(30) Foreign Application Priority Data
Aug. 18, 2004 (JP) 2004-238755

(51) Int. Cl. G06F 17/10

(52) U.S. Cl. 703/2

(57) ABSTRACT

In processing for generating a model for numerical analysis by dividing assemblies or components constituting the assemblies into cuboids to be units of analysis for the numerical analysis, a merge request receiving unit receives designation of assemblies or components to be objects of application of merge processing, and the analysis model generating unit executes the merge processing for the assemblies or components, for which designation is received, and generates an analysis model in which assemblies or components generated by the merge processing are divided into cuboids.

### BACKGROUND OF THE INVENTION

1) Field of the Invention

The present invention relates to a technology for generating a model for numerical analysis by dividing an assembly, or components that form the assembly, into elements to be units of analysis for the numerical analysis.

2) Description of the Related Art

In recent years, a computer program, which converts a geometric model of a machine or an apparatus represented by Computer Aided Design (CAD) data into an analysis model used for numerical analyses like structural analysis, heat transmission analysis, and fluid analysis, has been developed. A user can execute the analyses easily using the computer program.

An analysis model is a model that represents shapes of components with combinations of elements, which have simple shapes like a rectangular parallelepiped, for each of the components and allocates material data like a specific heat and a thermal conductivity used for numerical analysis to the respective elements (see Japanese Patent Application Laid-Open No. 2003-296380).

The shapes of the respective components forming the geometric model are represented by combining the elements having simple shapes in this way. This makes it possible to convert a geometric model of any complicated shape into an analysis model. In addition, it is possible to control decline in accuracy of numerical analysis by increasing the number of elements.

However, in a generation method for an analysis model according to the conventional technology, since conversion from a geometric model to an analysis model is performed for each component, there is a problem in that the number of elements of the analysis model increases when the number of components increases. When the number of elements of the analysis model increases, it takes time to carry out numerical analysis that uses the analysis model.

Therefore, when a geometric model including a large number of components is converted into an analysis model, it is important how an increase in the number of elements of the analysis model can be controlled and a calculation time in numerical analysis can be reduced.

### SUMMARY OF THE INVENTION

It is an object of the present invention to solve at least the problems in the conventional technology.

A model generation apparatus according to an aspect of the present invention generates a model for numerical analysis by dividing assemblies or components constituting the assemblies into elements to be units of analysis for the numerical analysis. The model generation apparatus includes a reception unit that receives designation of assemblies or components to be objects of application of merging; and a merging unit that merges the assemblies or components, for which designation is received by the reception unit, and generates a model in which assemblies or components generated by mergeing are divided into elements.

A model generation method according to another aspect of the present invention generates is a method of generating a model for numerical analysis by dividing assemblies or components constituting the assemblies into elements to be units of analysis for the numerical analysis. The model generation method includes receiving designation of assemblies or components to be objects of application of merging; and merging the assemblies or components, for which designation is received at the receiving, and generating a model in which assemblies or components generated at the merging are divided into elements.

A model generation program according to still another aspect of the present invention causes a computer to execute the above method according to the present invention.

A computer-readable recording medium according to still another aspect of the present invention stores therein a model generation program that causes a computer to execute the above method according to the present invention.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a diagram explaining merge processing for components according to an embodiment of the invention;

FIG. 2 is a diagram of a hierarchical structure of assemblies and components;

FIG. 3 is a diagram explaining merge processing for merging assemblies each other;

FIG. 4 is a functional block diagram of a functional structure of a model generation apparatus according to the embodiment;

FIG. 5 is a diagram explaining detailed shape merge processing that is performed by an analysis model generating unit shown in FIG. 4;

FIG. 6 is a diagram explaining an outermost shape merge processing that is performed by the analysis model generating unit shown in FIG. 4;

FIG. 7 is a diagram of an example of assembly data shown in FIG. 4;

FIG. 8 is a diagram of an example of component data shown in FIG. 4;

FIG. 9 is a flowchart of a processing procedure of model generation processing according to the embodiment;

FIG. 10 is a diagram of a structure of a computer system according to the embodiment; and

FIG. 11 is a block diagram of a structure of a main body unit in the computer system shown in FIG. 10.

### DETAILED DESCRIPTION

Exemplary embodiments of an apparatus, a method, and a computer product according to the present invention will be hereinafter explained in detail with reference to the accompanying drawings.

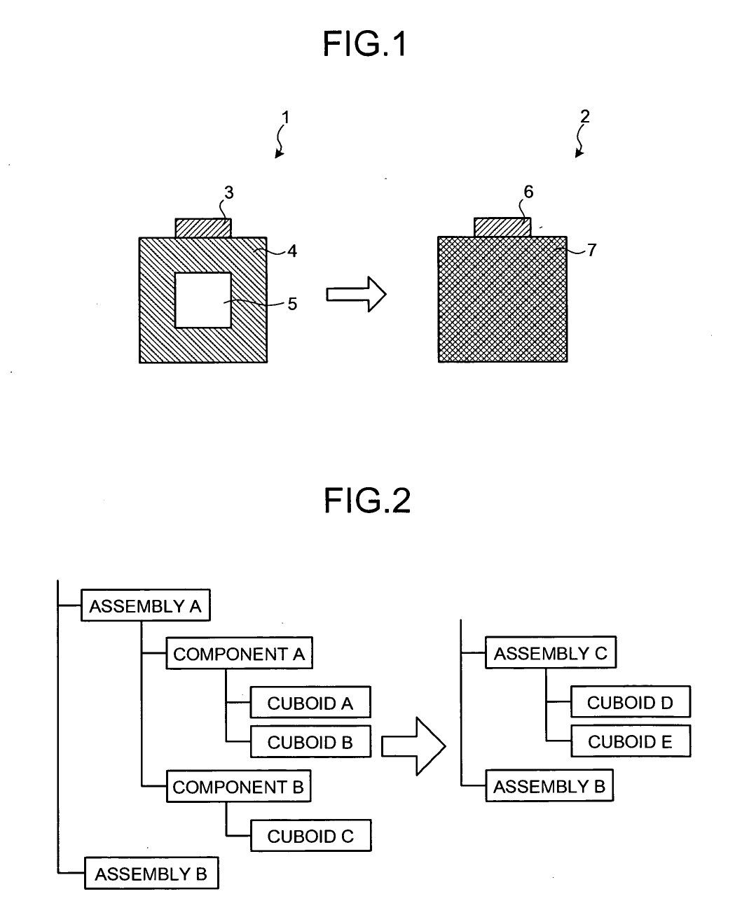

First, a concept of model generation processing according to an embodiment of the present invention will be explained. FIG. 1 is a diagram explaining merge processing of components according to this embodiment, and FIG. 2 is a diagram of a hierarchical structure of assemblies and components.

FIG. 1 shows an assembly A (1) of an analysis model converted from CAD data. An assembly is a set of components in which several components are combined. As shown in FIG. 2, in this example, the assembly A (1) includes a component A and a component B.

Shapes of respective components in an analysis model are represented using a rectangular parallelepiped called cuboid. In short, in the example in FIGS. 1 and 2, a shape of the component A is represented by a combination of a cuboid A (3) and a cuboid B (4). In addition, a shape of the component B is represented by a cuboid C (5).

When a user designates merge of the component A and the component B, the component A and the component B are merged by a unit of a component, and a new assembly C (2) including a cuboid D (6) and a cuboid E (7) is generated.

Therefore, since a cuboid is generated by a unit of a component to which the merge processing is applied rather than being generated for each component converted from CAD data, it is possible to reduce the number of cuboids. The merge processing is executed only for a part where it is considered that decline in calculation accuracy does not occur at the time of numerical analysis.

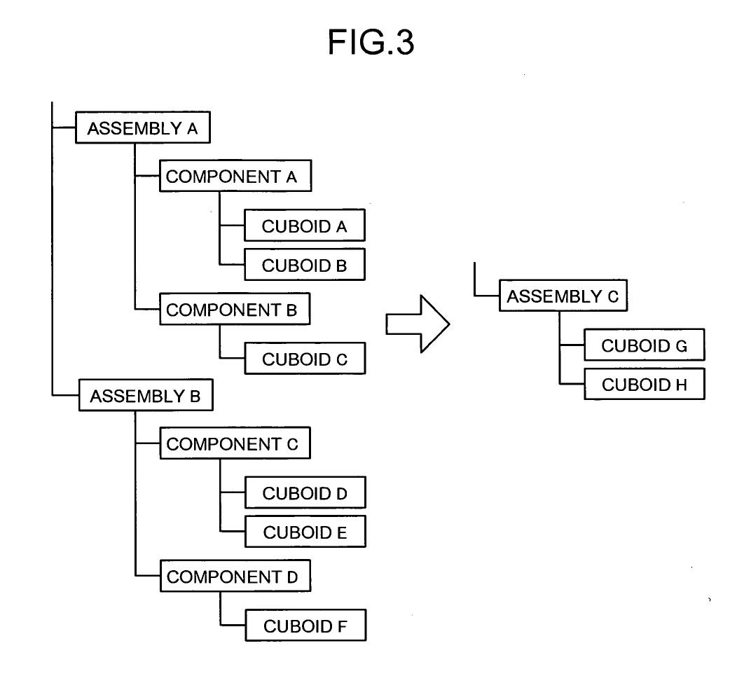

Although FIGS. 1 and 2 show an example in which components are merged with each other, assemblies may be merged with each other. FIG. 3 is a diagram explaining merge processing for merging assemblies with each other.

In an example of FIG. 3, an assembly A includes a component A and a component B. A shape of the component A is represented by a shape obtained by combining a cuboid A and a cuboid B, and a shape of the component B is represented by a cuboid C.

On the other hand, the assembly B includes a component C and a component D. A shape of the component C is represented by a shape obtained by combining a cuboid D and a cuboid E, and a shape of the component D is represented by a cuboid F.

When a user designates merge of the assembly A and the assembly B, the assembly A and the assembly B are merged by a unit of an assembly, and a new assembly C including a cuboid G and a cuboid H is generated.

In this case, since a cuboid is generated by a unit of an assembly to which the merge processing is applied rather than being generated for each component converted from CAD data, it is possible to reduce the number of cuboids.

Although the merge processing between components and the merge processing between assemblies are explained here, merge processing may be executed between an assembly and a component. In addition, merge processing between cuboids may be executed.

In this way, designation of assemblies or components to be objects of application of the merge processing is received, the merge processing for the assemblies or the components, for which the designation is received, is executed, and an analysis model, in which assemblies or components generated by the merge processing are divided into cuboids, is generated. Thus, it is possible to control an increase in the number of cuboids forming the analysis model and generate an analysis model, which reduces a calculation time in numerical analysis, by executing the merge processing between assemblies or between components or between an assembly and a component.

FIGS. 1 to 3 illustrate the case in which there are a few assemblies, components, and cuboids, however, in an analysis model converted from a geometric model with a complicated shape, since the number of cuboids is in an order of several tens thousand, the effects mentioned above are shown extremely markedly.

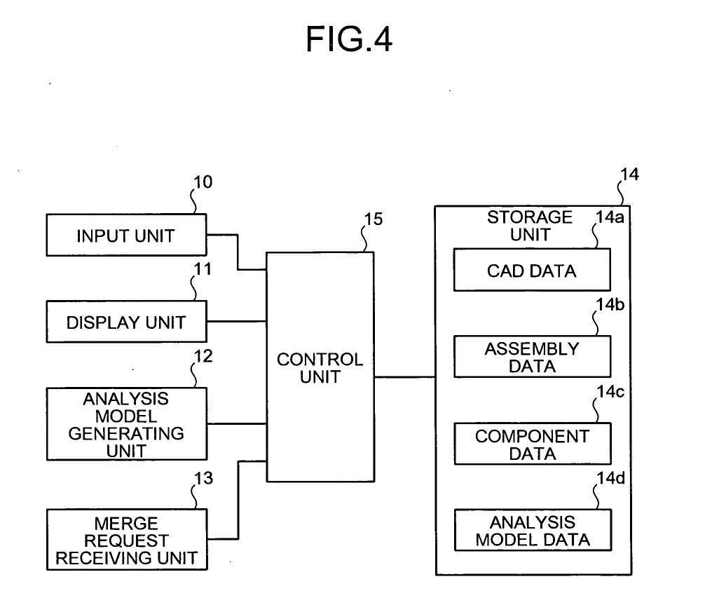

Next, a functional structure of the model generation apparatus according to this embodiment will be explained. FIG. 4 is a functional block diagram of the functional structure of the model generation apparatus according to this embodiment. As shown in FIG. 4, this model generation apparatus includes an input unit 10, a display unit 11, an analysis model generating unit 12, a merge request receiving unit 13, a storage unit 14, and a control unit 15.

The input unit 10 is an input device like a keyboard or a mouse. The display unit 11 is a display device like a display.

The analysis model generating unit 12 performs processing for reading CAD data 14a from the storage unit 14, generating an analysis model formed by a combination of cuboids from a geometric model represented by the CAD data 14a, allocating material data used for numerical analysis to the respective cuboids forming the analysis model, and outputting a result of the allocation.

When an analysis model is generated, the analysis model generating unit 12 receives selection of an outermost shape approximation method, an equal division method, or an unequal division method from a user and generates an analysis model by generating cuboids for each component with the selected method.

Here, the outermost shape approximation method is a method of, when cuboids are generated for each component, generating a cuboid, which includes the component and has a minimum volume, for the component. The equal division method is a method of generating cuboids obtained by dividing respective components equally. The unequal division method is a method of generating cuboids obtained by dividing components unequally according to shapes of the respective components. In the case of the equal division method and the unequal division method, the analysis model generating unit 12 receives information on the number of divisions for dividing the respective components from a user.

When the analysis model generating unit 12 receives an execution request for merge processing between assemblies, merge processing between components, merge processing between an assembly and a component, or merge processing between cuboids, the analysis model generating unit 12 executes the merge processing for which the execution request is received.

In addition, the analysis model generation unit 12 performs processing for allocating material data, which is used for numerical analysis, to respective cuboids of new assemblies or components generated by the merge processing. Moreover, the analysis model generating unit 12 performs processing for converting a format of the generated analysis model into a format for software for performing numerical analysis.

A method of the merge processing performed by the analysis model generating unit 12 includes detailed shape merge processing and outermost shape merge processing. First, the detailed shape merge processing will be explained. The detailed shape merge processing is processing for, when parts of certain assemblies or components are fitted in other assemblies or components, merging the fitted-in parts with the other assemblies or components while maintaining external shapes of the assemblies or the components.

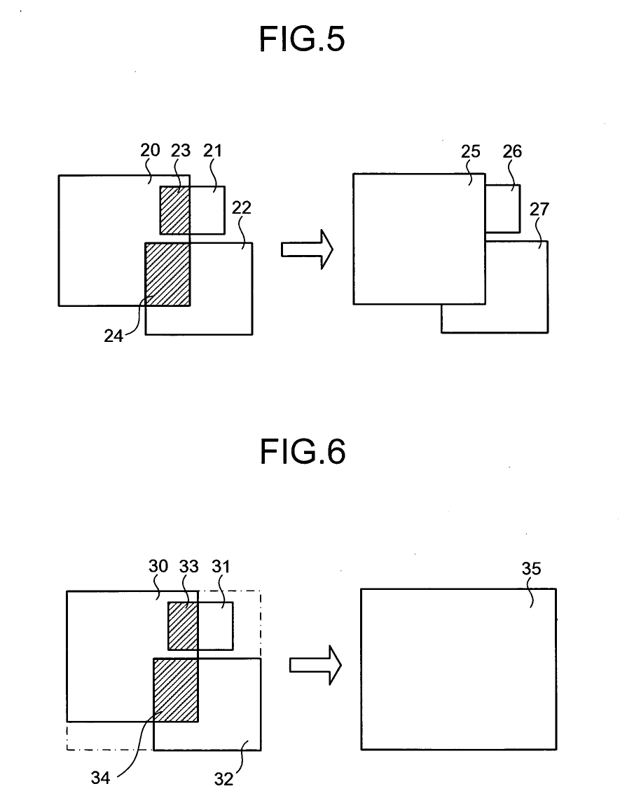

FIG. 5 is a diagram explaining detailed shape merge processing performed by the analysis model generating unit 12 shown in FIG. 4. In FIG. 5, a part 23 of a component 21 and a part 24 of a component 22 are fitted in a component 20.

When a user designates application of the merge processing to the components 20, 21, and 22, the analysis model generating unit 12 generates a new component 25 by integrating the part 23 of the component 21 and the part 24 of the component 22, which are fitted in the component 20, with the component 20. In addition, the analysis model generating unit 12 generates remaining parts of the components 21 and 22 as new components 26 and 27.

Material data is allocated anew to the component 25 generated by the merge processing anew. More specifically, in the components 20, 21, and 22 subjected to the merge processing, a volume of the component 20, a volume of the part 23 of the component 21 fitted in the component 20, and a volume of the part 24 of the component 22 fitted in the component 20 are compared, and material data of the component 20 having a maximum volume is allocated as material data of the component 25.

Next, the outermost shape merge processing, which is another merge method performed by the analysis model generating unit 12, will be explained. The outermost shape merge processing is processing for, when the merge processing is applied to assemblies or components, generating a new assembly or component that includes the respective assemblies or the respective components, to which the merge processing is applied, and has a minimum volume.

FIG. 6 is a diagram explaining the outermost shape merge processing performed by the analysis model generating unit 12 shown in FIG. 4. In FIG. 6, a part 33 of a component 31 and a part 34 of a component 32 are fitted in a component 30.

When a user designates application of merge processing to the components 30, 31, and 32, the analysis model generating unit 12 generates a new component 35 that includes the components 30, 31, and 32 and has a minimum volume.

Material data is allocated anew to the component 35 that is generated by the merge processing anew. For example, when material data such as a specific heat is allocated to the component 35, first, the analysis model generating unit 12 calculates a weighted average obtained by weighting specific heats of the respective components 20, 31, and 32 with volumes of the respective components 30, 31, and 32 and averaging the specific heats.

Then, the analysis model generating unit 12 performs processing for correcting the weighted average with a total of the volumes of the respective components 30, 31, and 32 and a ratio of the volume of the component 35 after merge and allocating the corrected value as a specific heat of the component 35.

FIGS. 5 and 6 illustrate the case in which components are merged with each other, however, even when the merge processing is applied to assemblies, an assembly and a component, or cuboids, the merge processing is executed in the same manner by the method described above, and material data is allocated to the respective cuboids.

Returning to the explanation of FIG. 4, the merge request receiving unit 13 performs processing for receiving designation of assemblies or components, for which the merge processing is executed, from a user. The merge request receiving unit 13 transmits information on the assemblies or components designated by the user, to the analysis model generating unit 12.

The storage unit 14 is a storage device like a hard disk device. This storage unit 14 stores CAD data 14a, assembly data 14b, component data 14c, and analysis model data 14d.

The CAD data 14a is data generated by a CAD system and is data like shape data of assemblies and respective components forming the assemblies. The assembly data 14b stores data related to the assemblies after the geometric model is converted into an analysis model. This assembly data 14b is generated for each assembly.

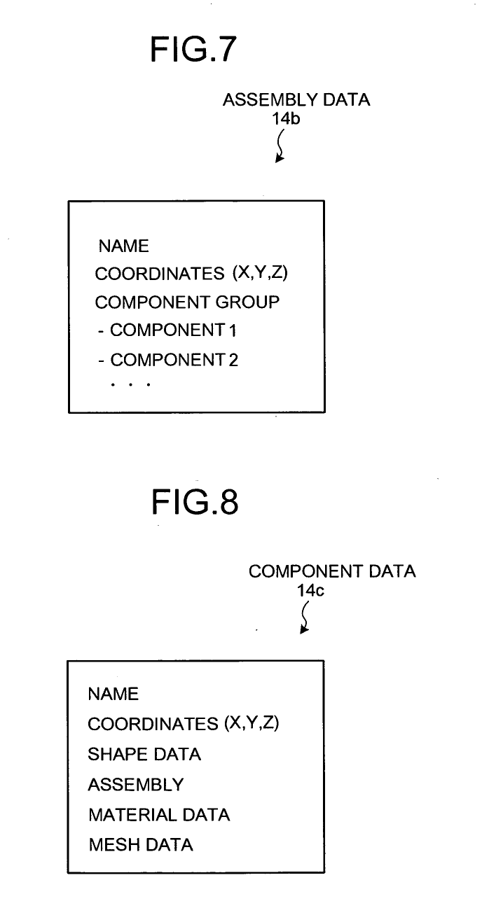

FIG. 7 is a diagram of an example of the assembly data 14b shown in FIG. 4. As shown in FIG. 7, the assembly data 14b stores respective kinds of information like a name, coordinates, and a component group. The name is information on a name given to an assembly. The coordinates are information on coordinates specifying a position of the assembly. The component group is information on respective components forming the assembly.

The component data 14c stores data related to the components after the shape data is converted into an analysis model. This component data 14c is generated for each component. FIG. 8 is a diagram of an example of the component data 14c shown in FIG. 4.

As shown in FIG. 8, the component data 14c stores respective kinds of information like a name, coordinates, shape data, assembly information, material data, and mesh data. The name is information on a name given to a component. The coordinates are information on coordinates specifying a position of the component. The shape data is data specifying a shape of the component. The assembly information is information on an assembly to which the component belongs. The material data is information on material characteristics like such as a specific heat and a thermal conductivity. The mesh data is information on a mesh for dividing the component into cuboids.

The analysis model data 14d is input data obtained by converting formats of the assembly data 14b and the component data 14c shown in FIGS. 7 and 8 into a format for software for performing numerical analysis.

The control unit 15 is a control unit that controls the entire model generation apparatus. The control unit 15 controls, for example, exchange of data among respective functional units.

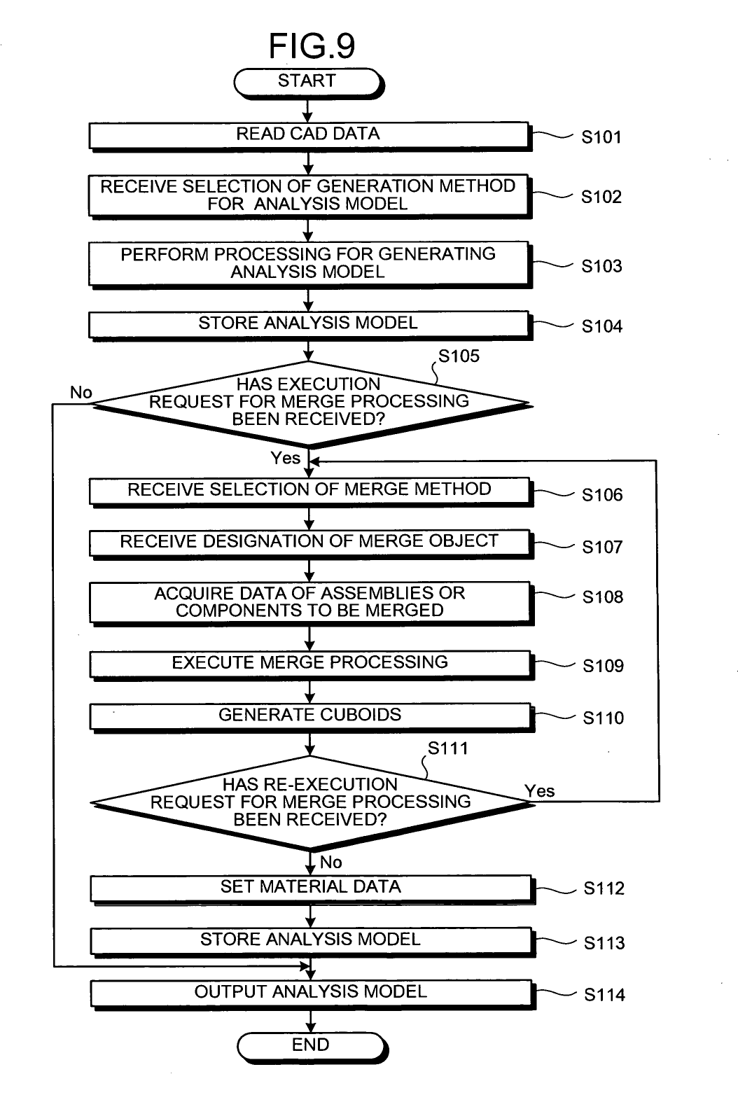

Next, a processing procedure of the model generation processing according to this embodiment will be explained. FIG. 9 is a flowchart of the processing procedure of the model generation processing according to this embodiment. As shown in FIG. 9, first, the analysis model generating unit 12 of the model generation apparatus reads the CAD data 14a (step S101).

Then, the analysis model generating unit 12 receives selection of a generation method for an analysis model from a user (step S102). More specifically, the analysis model generating unit 12 receives selection of the outermost shape approximation method, the equal division method, or the unequal division method from the user. When the equal division method or the unequal division method is selected, the analysis model generating unit 12 further receives information on the number of divisions for dividing respective components from the user.

Subsequently, the analysis model generating unit 12 performs processing for generating an analysis model, which is formed of cuboids and in which material data are allocated to the respective cuboid, from a geometric model represented by the CAD data 14a (step S103) and converts the generated analysis model into input data of numerical analysis software to store the input data as the analysis model data 14d (step S104).

Thereafter, the merge request receiving unit 13 checks whether an execution request for merge processing has been received from the user (step S105). If an execution request has not been received (No in step S105), the merge request receiving unit 13 performs processing for outputting the generated analysis model (step S114).

When an execution request for merge processing is received (Yes in step S105), the merge request receiving unit 13 receives selection of the detailed shape merge method or the outermost shape merge processing method shown in FIGS. 5 and 6 to be used from the user (step S106). Further, the merge request receiving unit 13 receives designation of assemblies or components to which the merge processing is applied (step S107).

Thereafter, the analysis model generating unit 12 acquires data of the designated assemblies or components from the assembly data 14b and the component data 14c (step S108). Then, the analysis model generating unit 12 executes the merge processing for the assemblies or the components based on the acquired assembly data 14b and the component data 14c (step S109) and performs processing for generating cuboids for assemblies or components that are generated anew by the merge processing (step S110).

Subsequently, the merge request receiving unit 13 checks whether a re-execution request for the merge processing has been received (step S111) and, if a re-execution request has been received (Yes in step S111), continues the processing in step S106 and the subsequent steps.

If a re-execution request for the merge processing has not been received (No in step S111), the analysis model generating unit 12 sets material data in the cuboids generated anew (step S112) and converts an analysis model after the merge processing is applied into input data of numerical analysis software to store the input data as the analysis model data 14d (step S113).

Thereafter, the analysis model generating unit 12 outputs the generated analysis model data 14d (step S114) and ends this model generation processing.

Incidentally, it is possible to realize the model generation apparatus and the model generation method described above by executing a program prepared in advance in a computer system like a personal computer or a workstation. A computer system, which executes a model generation program having the same function as the model generation apparatus (model generation method) described above, will be hereinafter explained.

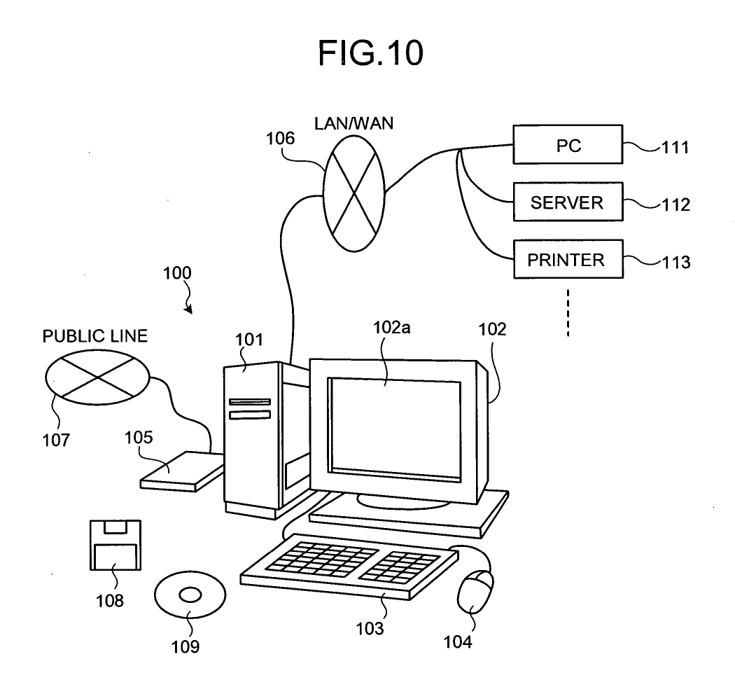

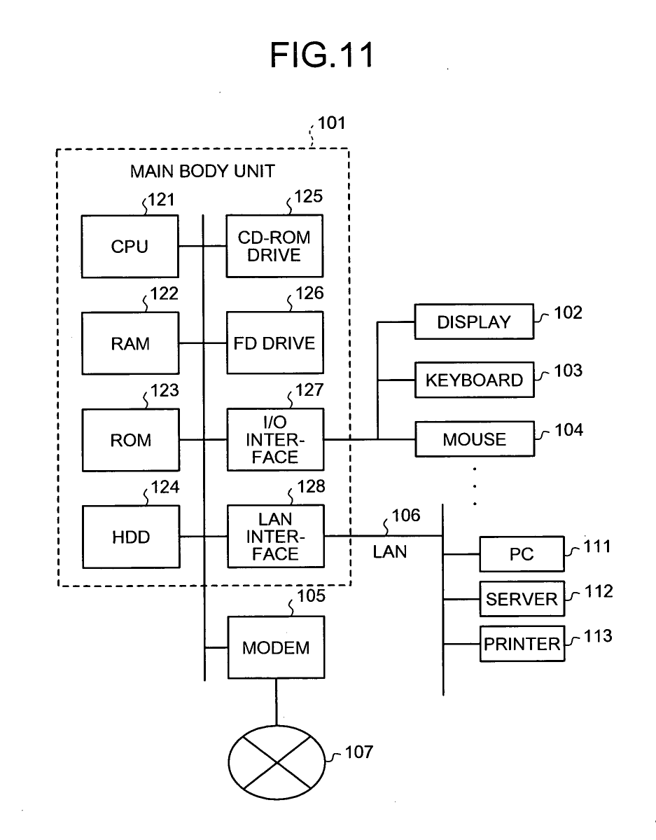

FIG. 10 is a diagram of a structure of a computer system 100 according to this embodiment. FIG. 11 is a block diagram of a structure of a main body unit 101 in the computer system shown in FIG. 10.

As shown in FIG. 10, the computer system 100 according to this embodiment includes the main body unit 101, a display 102 for displaying information like an image on a display screen 102a according to an instruction from the main body unit 101, a keyboard 103 for inputting various kinds of information to this computer system 100, and a mouse 104 for designating an arbitrary position on the display screen 102a of the display 102.

In addition, as shown in FIG. 11, the main body unit 101 in this computer system 100 includes a CPU 121, a RAM 122, a ROM 123, a hard disk drive (HDD) 124, a CD-ROM driver 125 that receives a CD-ROM 109, an FD drive 126 that receives a flexible disk (FD) 108, an I/O interface 127 that connects a display 102, a keyboard 103, and a mouse 104, and a LAN interface 128 that connects with a local area network or a wide area network (LAN/WAN) 106.

Moreover, a modem 105 for making connection with a pubic line 107 like the Internet is connected to this computer system 100, and other computer systems (PCs) 111, servers 112, printers 113, and the like are also connected to the computer system 100 via the LAN interface 128 and the LAN/WAN 106.

The computer system 100 realizes a model generation apparatus (model generation method) by reading out and executing a model generation program recorded in a predetermined recording medium. Here, the predetermined recording medium includes, other than “portable physical media” such as the flexible disk (FD) 108, the CD-ROM 109, an MO disk, a DVD disk, a magneto-optical disk, and an IC card, all recording media, which record a model generation program readable by the computer system 100, like “fixed media” such as the hard disk drive (HDD) 124, the RAM 122, and the ROM 123 provided inside and outside the computer system 100, and “communication media”, which hold a program for a short period in transmission of the program, such as the public line 107 connected via the modem 105 and the LAN/WAN 106 to which the other computer systems 111 and servers 112 are connected.

In other words, the model generation program is recorded in the recording media such as the “portable physical media”, the “fixed media”, and the “communication media” to be readable by a computer. The computer system 100 realizes the model generation apparatus and the model generation method by reading out and executing the model generation program from such recording media.

Note that the model generation program is not limited to be executed by the computer system 100. It is also possible to apply the invention to a case in which the other computer systems 111 or servers 112 execute the model generation program and a case in which the other computer systems 111 and servers 112 cooperate to execute the model generation program.

As described above, in this embodiment, the merge request receiving unit 13 receives designation of assemblies or components to be objects of application of the merge processing, and the analysis model generating unit 12 executes the merge processing for the assemblies or the components, for which the designation is received, and generates an analysis model in which assemblies or components generated by the merge processing are divided into cuboids. Thus, it is possible to control an increase in the number of cuboids and generate an analysis model that reduces a calculation time in numerical analysis.

The analysis model generating unit 12 executes the merge processing by generating an assembly or a component that includes assemblies or components to which the merge processing is applied and has a minimum volume. Thus, it is possible to control an increase in the number of cuboids and generate an analysis model, which reduces a calculation time in numerical analysis, by reducing the number of assemblies or components.

When the merge processing is applied to assemblies or components, the analysis model generating unit 12 determines material characteristics of respective cuboids of assemblies or components generated by the merge processing based on a volume ratio of the merged respective assemblies or respective components. Thus, it is possible to allocate the material characteristics to the respective cuboids of the assemblies or the components generated by the merge processing to control decline in accuracy of numerical analysis.

When assemblies or components, to which the merge processing is applied, are fitted in other assemblies or components, the analysis model generating unit 12 executes the merge processing by integrating fitted-in parts of the assemblies or the components and the other assemblies or components. Thus, it is possible to control an increase in the number of cuboids and generate an analysis model, which reduces a calculation time in numerical analysis, by simplifying shapes of assemblies or components.

When the merge processing is applied to assemblies or components, the analysis model generating unit 12 determines material characteristics of respective cuboids of assemblies or components generated by the merge processing based on information on volumes of fitted-in parts where the respective assemblies or the respective components are fitted in other assemblies or components. Thus, it is possible allocate the material characteristics to the respective cuboids of the assemblies or the components generated by the merge processing.

An embodiment of the present invention has been explained above. However, the invention may be implemented in various different embodiments within a range of the technical thought described in the patent claims other than the embodiment described above.

For example, in above embodiment, the merge processing is executed after generating an analysis model from a geometric model once. However, the invention is not limited to this, and it is also possible that the merge processing for assemblies or components is executed at a stage of a geometric model and processing for dividing the assemblies or the components, to which the merge processing is applied, into cuboids is executed when the geometric model is converted into an analysis model.

Among the respective pieces of processing explained in this embodiment, all or part of the pieces of processing, which are explained as being performed automatically, may be performed manually, or all or part of the pieces of processing, which are explained as being performed manually, may be performed automatically by a publicly-known method. Besides, the processing procedures, the control procedures, the specific names, and the information including various data and parameters indicated in the specification and the drawings may be changed arbitrarily unless specifically noted otherwise.

Further, the respective elements of the model generation apparatus shown in the figures are functionally conceptual and are not always required to be physically constituted as shown in the figures. In other words, specific forms of distribution and integration of the elements of the model generation apparatus are not limited to those shown in the figures. The model generation apparatus may be constituted by functionally or physically distributing and integrating all or part of the elements by an arbitrary unit according to various loads, states of use, and the like.

Moreover, all or arbitrary part of the respective processing functions to be performed in the model generation apparatus can be realized by a CPU and a program, which is analyzed and executed by the CPU, or realized as hardware according to a wired logic.

According to the invention, it is possible to reduce the number of elements and/or the number of assemblies or components. As a result, it is possible to reduces the calculation time in numerical analysis.

When the merge processing is applied to assemblies or components, material characteristics of respective elements of assemblies or components generated by the merge processing are determined based on a volume ratio of the merged respective assemblies or respective components. Thus, there is an effect that it is possible to allocate the material characteristics to the respective elements of the assemblies or the components generated by the merge processing to control decline in accuracy of numerical analysis.

When assemblies or components, to which the merge processing is applied, are fitted in other assemblies or components, the merge processing is executed by integrating fitted-in parts of the assemblies or the components and the other assemblies or components. Thus, there is an effect that it is possible to control an increase in the number of elements and generate an analysis model, which reduces a calculation time in numerical analysis, by simplifying shapes of assemblies or components.

When the merge processing is applied to assemblies or components, material characteristics of respective elements of assemblies or components

When the merge processing is applied to assemblies or components, material characteristics of respective elements of assemblies or components generated by the merge processing are determined based on information on volumes of fitted-in parts in which the respective assemblies or the respective components are fitted in other assemblies or components. Thus, there is an effect that it is possible to allocate the material characteristics to the respective elements of the assemblies or components generated by the merge processing.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. A model generation program that causes a computer to execute processing for generating a model for numerical analysis by dividing assemblies or components constituting the assemblies into elements to be units of analysis for the numerical analysis, the model generation program causing a computer to execute:
receiving designation of assemblies or components to be objects of application of merging; and
merging the assemblies or components, for which designation is received at the receiving, and generating a model in which assemblies or components generated at the merging are divided into elements.

2. The model generation program according to claim 1, wherein, at the merging, the merging is executed by generating an assembly or a component that includes the assemblies or the components that are merged and has a minimum volume.

3. The model generation program according to claim 2, wherein, at the merging, when merging the assemblies or components, material characteristics of elements of assemblies or components generated by the merging are determined based on a volume ratio of the merged respective assemblies or respective components.

4. The model generation program according to claim 1, wherein, at the merging, when the assemblies or components that are to be merged, belog to other assemblies or components, the merging is executed by integrating fitted-in parts of the assemblies or components with the other assemblies or components.

5. The model generation program according to claim 4, wherein, at the merging, when merging the assemblies or components, material characteristics of the elements of the assemblies or the components generated at the merging are determined based on information on volumes of fitted-in parts where the respective assemblies or the respective components are fitted in other assemblies or components.

6. A model generation apparatus that generates a model for numerical analysis by dividing assemblies or components constituting the assemblies into elements to be units of analysis for the numerical analysis, comprising:
a reception unit that receives designation of assemblies or components to be objects of application of merging; and
a merging unit that merges the assemblies or components, for which designation is received by the reception unit, and generates a model in which assemblies or components generated by mergeing are divided into elements.

7. The model generation apparatus according to claim 6, wherein the merge unit executes the merging by generating an assembly or a component that includes the assemblies or the components that are merged and has a minimum volume.

8. The model generation apparatus according to claim 7, wherein, when the merge processing is applied to assemblies or components, the merge unit determines material characteristics of elements of assemblies or components generated by the merge processing based on a volume ratio of the merged respective assemblies or respective components.

9. The model generation apparatus according to claim 6, wherein, when assemblies or components, to which the merge processing is applied, are fitted in other assemblies or components, the merge unit executes the merge processing by integrating fitted-in parts of the assemblies or components with other assemblies or components.

10. The model generation apparatus according to claim 9, wherein, when the merge processing is applied to assemblies or components, the merge unit determines material characteristics of elements of assemblies or components generated by the merge processing based on information on volumes of fitted-in parts where the respective assemblies or the respective components are fitted in other assemblies or components.

11. A model generation method of generating a model for numerical analysis by dividing assemblies or components constituting the assemblies into elements to be units of analysis for the numerical analysis, comprising:
receiving designation of assemblies or components to be objects of application of merging; and
merging the assemblies or components, for which designation is received at the receiving, and generating a model in which assemblies or components generated at the merging are divided into elements.

12. The model generation method according to claim 11, wherein, at the merging, the merging is executed by generating an assembly or a component that includes the assemblies or the components that are merged and has a minimum volume.

13. The model generation method according to claim 12, wherein, at the merging, when merging the assemblies or components, material characteristics of elements of assemblies or components generated by the merging are determined based on a volume ratio of the merged respective assemblies or respective components.

14. The model generation method according to claim 11, wherein, at the merging, when the assemblies or components that are to be merged, belog to other assemblies or components, the merging is executed by integrating fitted-in parts of the assemblies or components with the other assemblies or components.

15. The model generation method according to claim 14, wherein, at the merging, when merging the assemblies or components, material characteristics of the elements of the assemblies or the components generated at the merging are determined based on information on volumes of fitted-in parts where the respective assemblies or the respective components are fitted in other assemblies or components.

16. A computer-readable recording medium that stores therein a model generation program that causes a computer to execute processing for generating a model for numerical analysis by dividing assemblies or components constituting the assemblies into elements to be units of analysis for the numerical analysis, the model generation program causing a computer to execute:
receiving designation of assemblies or components to be objects of application of merging; and
merging the assemblies or components, for which designation is received at the receiving, and generating a model in which assemblies or components generated at the merging are divided into elements.
